(19) United States
(12) Patent Application Publication
(10) Pub. No.: US 2007/0057406 A1
(43) Pub. Date: Mar. 15, 2007

(54) Method of shaped sleeve forming and its apparatuses

(76) Inventor: I-Jan Bill Fang, Kaohsiung (TW)

Correspondence Address: CHARLES E. BAXLEY, ESQ., 90 JOHN STREET, THIRD FLOOR, NEW YORK, NY, 10038, US

(21) Appl. No.: 11/225,458

(22) Filed: Sep. 13, 2005

(51) Int. Cl. B29C 35/02

(52) U.S. Cl. 264/319; 425/383

(57) ABSTRACT

The present invention provides a method of shaped sleeve forming, the detail steps are to jacket gob on the forming block, and take it to pass through heat transfer medium to carry out hot-forming treatment, and said heat transfer medium is liquid. Since applying said project, the present invention takes the water as heat transfer medium, comparing to air, the specific heat of water is higher than air, so it is easy to be heated, and lose heat slowly, and loss of heat is less, so that it heated is not easy to be cooled, thereby the hot-water tank is easy to be kept in a constant temperature by said thermostat in a saving power state. On the other hand, as said gob is sunk into the hot-water oven, it is surrounded by the hot water fully, so as to be heated homogeneously, and produce the goods with smooth and very good exterior.

### BACKGROUND OF THE INVENTION

1. Field of the Invention

The present invention relates to a film sleeve hot-forming treatment, and more especially to a method of shaped sleeve forming and its apparatuses.

2. Description of Prior Art

In accordance with the conventional technology of shaped sleeve forming, as shown in FIG. 1, the detail steps is to jacket the pre-mold sleeve gob on the forming block, then put the forming block with the gob on the belt conveyer 1′, next it is took to pass through a heating channel heated by electrical bars or air heater 2′ to make the gob hot-form in there. In this way, due to the air working as heat transfer medium, and instability of the air flow, said gob is heated non-uniform, and it is difficult to be kept in a desired constant temperature in the channel, so the manufactured goods are not smooth in exterior with some corrugations to occur to waste material. On the other hand, due to the lower specific heat of air, the heat is easy to lose; therefore, the heat energy is commanded more, so the power consumption is bigger.

### OBJECTS AND SUMMARY OF THE INVENTION

It is therefore the main object of the present invention to provide a method of shaped sleeve forming and its apparatuses, in which the gob is heated homogeneously, the exterior of goods is good and the calorific efficiency is high.

For archiving the objects, the technical solution provided by the present invention is to provide a method of shaped sleeve forming, therein jacket the gob over the forming block, then take the jacketed forming block to pass through a heated heat transfer medium to make it hot-form; wherein, said heat transfer medium can be a kind of liquid.

Said liquid working as heat transfer medium can be oil or water.

The detail steps are as follows: jacket the gob on the forming block one by one, then put it on the belt conveyer, next it is took to sink into and pass through a water tank filled with heated water in a desired constant temperature, after it is hot-formed in the tank, it is took off.

Based on the above-mentioned method, an apparatuses is comprised of a driving chain wheel, a driven chain wheel, a belt conveyer, a water tank and framework; said driving and driven chain wheels are separately mounted on the both ends of the framework; said belt conveyer is laid over crossing said both chain wheels so that the driving chain wheel can drive the driven chain wheel via said belt conveyer; said water tank is mounted on the framework on the halfway of said belt conveyer between the both chain wheels so that a section of the belt conveyer is sunk into the water tank.

Said water tank is attached with a thermostat for keeping the oven in a desired constant temperature.

After applying said project, the present invention takes the water as heat transfer medium, comparing to air, the specific heat of water is higher than air, so it is easy to be heated, and lose heat slowly, and loss of heat is less, so that it heated is not easy to be cooled, thereby the hot-water tank is easy to be kept in a constant temperature by said thermostat in a saving power state. On the other hand, as said gob is sunk into the hot-water oven, it is surrounded by the hot water fully, so as to be heated homogeneously, and produce the goods with smooth and very good exterior.

### BRIEF DESCRIPTION OF THE DRAWINGS

FIG. 1 is a solid view showing the apparatuses of the present invention.

FIG. 2 is a top-side view showing the apparatuses of the present invention.

FIG. 3 is a front-side view showing the apparatuses of the present invention.

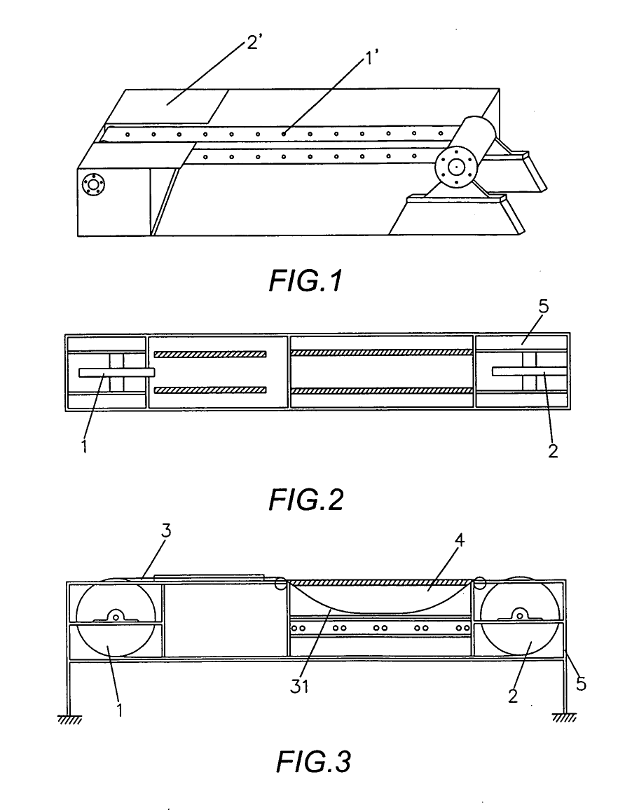

### DETAILED DESCRIPTION OF PREFERRED EMBODIMENTS

The present invention provides a method of shaped sleeve forming, in which the gob is jacketed on the forming block firstly, then put it on the belt conveyer, next it is took to sink into and pass through a water tank filled with heated water in a desired constant temperature, after it is hot-formed in the tank, it is took off.

Said water tank 4 is mounted on the framework 5 on the halfway of said belt conveyer 3 between the both chain wheels 1 and 2 so that a section 31 of the belt conveyer 3 is sunk into the water tank 4, and the loaded forming block placed on the belt conveyer 3 can be sunk into the water tank 4 too to carry out hot-forming treatment. For keeping the oven in desired constant temperature, water tank is attached with a thermostat (not shown in drawings). The features of the present invention are to take liquid as heat transfer medium, such like oil or water cooperating to its evaporant. Whatever applying hot-water or hot-oil to carry out hot-forming treatment is in the claimed range of the present invention, although hot-water is described as an embodiment.

I claim:

1. a method of shaped sleeve forming, the detail steps are to jacket gob on the forming block, and take it to pass through heat transfer medium to carry out hot-forming treatment; wherein, said heat transfer medium is liquid;

2. a method of shaped sleeve forming as claimed in claim 1, wherein, said heat transfer medium is liquid;

3. a method of shaped sleeve forming as claimed in claim 2, wherein, said liquid is oil or water;

4. a method of shaped sleeve forming as claimed in claim 1, wherein, said detail steps are as follows: jacket the gob on the forming block one by one, then put it on the belt conveyer, next it is took to sink into and pass through a water tank filled with heated water in a desired constant temperature, after it is hot-formed in the tank, it is took off;

5. a apparatus based on the claimed claim 1, wherein said apparatuses is comprised of a driving chain wheel, a driven chain wheel, a belt conveyer, a water tank and framework; said driving and driven chain wheels are separately mounted on the both ends of the framework; said belt conveyer is laid over crossing said both chain wheels so that the driving chain wheel can drive the driven chain wheel via said belt conveyer; said water tank is mounted on the framework on the halfway of said belt conveyer between the both chain wheels so that a section of the belt conveyer is sunk into the water tank;

6. a apparatus based on the claimed claim 2, wherein said water tank is attached with a thermostat for keeping the oven in a desired constant temperature;
